(19) United States
(12) Patent Application Publication
(10) Pub. No.: US 2017/0089840 A1
(43) Pub. Date: Mar. 30, 2017

(54) INSPECTION APPARATUS, AND ARTICLE MANUFACTURING METHOD

(71) Applicant: CANON KABUSHIKI KAISHA, Tokyo (JP)

(72) Inventor: Hidenori Hashiguchi, Utsunomiya-shi (JP)

(21) Appl. No.: 15/277,765

(22) Filed: Sep. 27, 2016

(30) Foreign Application Priority Data
Sep. 30, 2015 (JP) 2015-194023

(51) Int. Cl. G01N 21/88; G06T 7/00

(52) U.S. Cl. CPC G01N 21/8806; G06T 7/0004; G06T 2207/10004; G06T 2207/30108; G06T 2207/10152; G01N 2201/12; G01N 2201/061

(57) ABSTRACT

An inspection apparatus for performing inspection of an object includes an illumination device that illuminates an object, an imaging device that images the illuminated object, and a processor configured to perform inspection processing based on plural images obtained by the imaging device respectively corresponding to plural light emitting regions of the illumination device. Two light emitting regions of the plural light emitting regions corresponding to mutually adjoining two azimuths of plural azimuths that illuminate the object have a mutually overlapping region.

### BACKGROUND

Field

Aspects of the present invention generally relate to an inspection apparatus for inspecting an object and an article manufacturing method.

Description of the Related Art

In production sites of industrial products, objects are inspected to reduce defects. Inspection of the objects is performed in one or more processes in a manufacturing process of a product with varying degrees of required accuracy. Inspection by subjective evaluation of human inspectors can result in inspection result differences between inspectors. For example, in appearance inspection by viewing the objects, there are many types of features of defects to be inspected. Some defects, like color unevenness, spots and cracks, are difficult to inspect because of their uncertain shape and size. In these circumstances, objective inspection by an inspection apparatus is desired.

Illumination technology and image composition technology are techniques that are available for such an inspection apparatus. As the illumination technology, a low angle illumination in which an object is illuminated from a low angle can be employed to detect three-dimensional defects, such as scratch-like defects, on the object. Non-defective parts and defective parts having different inclination angles have, when illuminated from the same direction, different directions of regular reflection light. The low angle illumination can be used to image non-defective parts dark and defective parts bright using this feature (see Japanese Patent Laid-Open No. 2014-055913).

With respect to a case where a plane extending between an optical axis of an illumination system and an optical axis of an image capturing system crosses a direction perpendicularly in which a crack extends and a case where the plane is in parallel with the direction in which the crack extends, the former case has a greater difference in brightness (an S/N ratio) between the non-defective parts and the defective parts. Since the S/N ratio can vary in accordance with the illumination azimuth, the illumination azimuth is variable (see Japanese Patent Laid-Open No. 2014-215217). Japanese Patent Laid-Open No. 2014-215217 further discloses a technique of composing plural images obtained by imaging, and performing image processing on the obtained composed image (an inspection image) to detect a defect.

The inspection apparatus described in Japanese Patent Laid-Open No. 2014-215217 requires illumination from many azimuths to obtain an image of a high S/N ratio. An increase in the number of illumination azimuths can prolong the inspection time (i.e., the tact time or cycle time).

### SUMMARY

Aspects of the present invention provide, for example, an inspection apparatus advantageous in both accuracy and time consumption of inspection.

According to an aspect of the present invention, an inspection apparatus for performing inspection of an object, the inspection apparatus including an illumination device configured to illuminate the object, an imaging device configured to image the illuminated object, and a processor configured to perform inspection processing based on plural images obtained by the imaging device respectively corresponding to plural light emitting regions of the illumination device, wherein the apparatus is configured such that two light emitting regions of the plural light emitting regions respectively corresponding to mutually adjoining two azimuths of plural azimuths that illuminate the object have a mutually overlapping region.

Further features of aspects of the present invention will become apparent from the following description of exemplary embodiments with reference to the attached drawings.

### BRIEF DESCRIPTION OF THE DRAWINGS

FIG. 1 illustrates an exemplary configuration of an inspection apparatus.

FIG. 2 illustrates an exemplary configuration of an illumination device and an imaging device (seen from a Z-axis direction).

FIG. 3 illustrates an exemplary configuration of an illumination device and an imaging device (seen from a Y-axis direction).

FIG. 4 illustrates a processing flow to generate an inspection image.

FIG. 5 illustrates an exemplary relationship between illumination patterns and light emission states of light sources.

FIG. 6 illustrates another exemplary relationship between illumination patterns and light emission states of the light sources.

FIG. 7 illustrates another exemplary processing flow to obtain an inspection image.

FIG. 8 illustrates another exemplary relationship between illumination patterns and light emission states of the light sources.

### DESCRIPTION OF THE EMBODIMENTS

Hereafter, embodiments of the present invention are described with reference to the drawings. In the drawings, the same components are denoted by the same reference numerals unless otherwise stated and repeated description thereof is omitted.

### First Embodiment

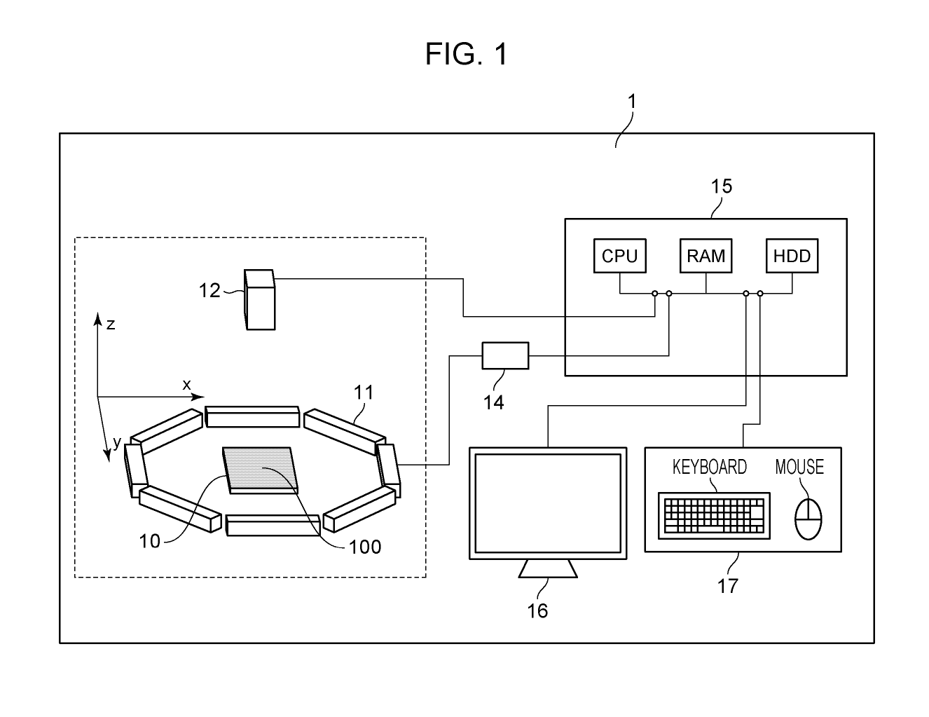

An inspection apparatus 1 according to a first embodiment is described with reference to FIG. 1. FIG. 1 illustrates an exemplary configuration of the inspection apparatus 1. The inspection apparatus 1 inspects a work 10 that is an object, such as a metal part and a resin part, used in industrial products. In the present embodiment, the work 10 including a surface 100 is inspected by appearance inspection. The surface 100 of the work 10 is, for example, a satin finished surface, and can have an uneven three-dimensional defect, such as a crack and a dent.

The inspection apparatus 1 inspects the work 10 to detect a defect produced in an inspecting region on the surface 100 based on an image of the surface 100 of the work 10 and, for example, sorts the work 10 into a non-defective or a defective group based on the inspection result. The inspecting region can be set on the entire surface 100 or in a part of the surface 100 excluding areas requiring no inspection.

The inspection apparatus 1 includes an illumination device 11, an imaging device 12 (a camera), a control unit 14, a processor 15, a display unit 16, and an input unit 17. The control unit 14 controls the illumination device 11. In another embodiment, the processor 15 controls the illumination device 11 and the control unit 14 is not needed.

The work 10 is conveyed to a predetermined position by an unillustrated conveying device. The illumination device 11 illuminates the conveyed work 10. The imaging device 12 images the surface 100 of the work 10 illuminated in a dark field using the illumination device 11. Illumination by the illumination device 11 can be bright field illumination depending on a type of a defect to be inspected. The imaging device 12 images the work 10 illuminated by the illumination device 11 and obtains an image. The image of the surface 100 obtained by the imaging device 12 is transferred to the processor 15.

The processor 15 can be an information processing apparatus including a central processing unit (CPU), random access memory (RAM), and a hard disk drive (HDD), for example. The processor 15 performs processing for inspecting the work 10 based on plural images corresponding to plural light emitting regions of the illumination device 11 obtained by the imaging device 12. The processing to generate the inspection image by the processor 15 is described below. The processor 15 obtains an evaluation value based on the inspection image, and performs processing to sort the work 10 into a particular group, e.g., a non-defective group or a defective group based on the evaluation value and a threshold of each group.

The CPU executes a program for image processing or sort processing in cooperation with the RAM and stores the obtained result in the HDD. The display unit 16 includes, for example, a monitor, and displays a result of the processing obtained by the processor 15. The input unit 17 includes, for example, a keyboard and a mouse, and transmits information input by a user to the processor 15.

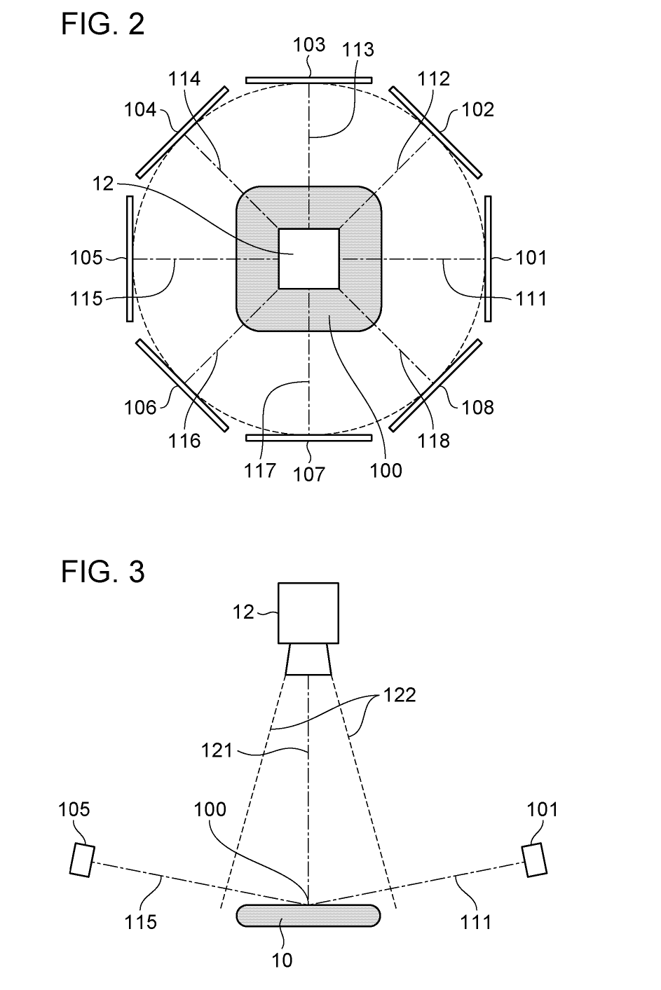

Details of the illumination device 11 and the processor 12 are described with reference to FIGS. 2 and 3. FIGS. 2 and 3 illustrate exemplary configurations of the illumination device and the imaging device. FIG. 2 is a diagram seen from a Z-axis direction and FIG. 3 is a diagram seen from a Y-axis direction. In the present embodiment, the illumination device 11 includes plural light sources. In FIG. 2, the illumination device 11 includes light sources 101 to 108. The light sources 101 to 108 are disposed to be rotationally symmetric about an optical axis of the imaging device 12. Each of the light sources 101 to 108 includes a rectangular light emitting surface. The light emitting surface can be constituted by an arrangement of LED. The light sources 101 to 108 include optical axes 111 to 118, respectively. The light sources 101 to 108 are disposed to surround the surface 100.

As illustrated in FIG. 3, the optical axes 111 to 118 are disposed at the same angle with respect to the surface 100. The imaging device 12 is disposed so that an optical axis 121 illustrated by a one-dot chain line perpendicularly crosses the surface 100 and passes through the center (the center of gravity) of the surface 100. An area 122 illustrated by a broken line represents an imaging range (a field of view) of the imaging device 12. The optical axis of each light source designates a straight line extending in a direction perpendicular to the light emitting surface from the center (the center of gravity) of the light emitting surface.

The illumination device 11 can include a ring-shaped light source and can illuminate the object independently from each divided area of the light emitting region. Alternatively, the light source 101 can be rotated about the work 10 by an unillustrated driving unit. In this case, the light sources 102 to 108 are not provided. Although eight light sources are provided in the present embodiment, the number of the light sources can be changed depending on the size, shape, or light reflection characteristics of the work 10, the level required for visualization of the defect, etc.

As described above, by disposing the light sources along the circumference, the crack can be illuminated from all the directions substantially perpendicular thereto. By sequentially illuminating with plural light sources disposed on the circumference, an image of a higher S/N ratio than that of an image illuminated simultaneously with all the light sources can be obtained. In order to obtain this effect, the light emitting region is divided into at least two parts (i.e., at least two illumination azimuths) along the circumference and, the central angle of a sector is set with one light emitting region (e.g., the light emitting region of the light source 101) being considered as a circular arc to less than or equal to 180° in FIG. 2. If the direction perpendicular to the direction of the crack coincides with the direction of either of the optical axis 111 or the optical axis 118, an image of a relatively high S/N ratio can be obtained. If the direction perpendicular to the direction of the crack is located between the directions of two adjoining optical axes, an image of a relatively low S/N ratio is obtained.

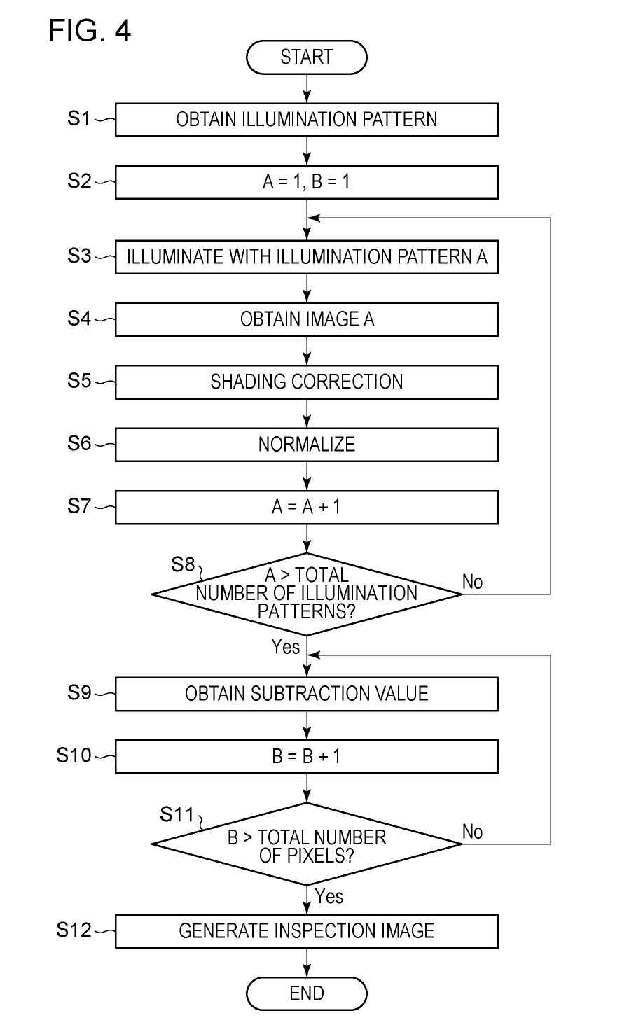

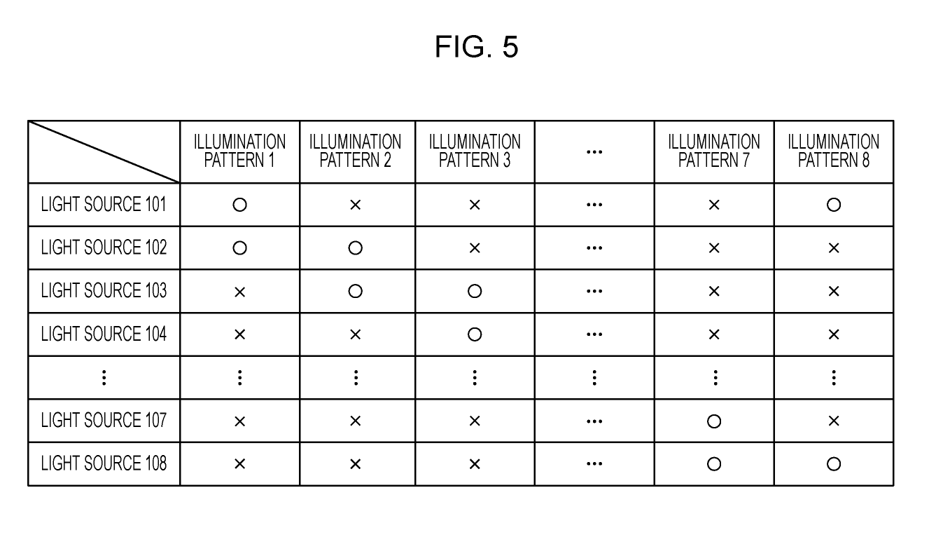

Next, generation of an inspection image is described with reference to FIGS. 4 and 5. FIG. 4 illustrates a processing flow to generate an inspection image. FIG. 5 illustrates a relationship between illumination patterns and light emission states of the light sources. In FIG. 4, an illumination pattern is obtained (set) first (step S1). The illumination pattern (the light emitting region) is described with reference to FIG. 5. FIG. 5 illustrates correlations between the illumination patterns 1 to 8 (8 azimuths) and the light emission states of the light sources 101 to 108. For example, the illumination pattern 1 makes the light sources 101 and 102 emit light (o) and does not make other light sources 103 to 108 emit light (x). In two adjoining illumination patterns, i.e., light emitting regions that adjoin in the illumination azimuths, among the illumination patterns 1 to 8, some of the light sources 101 to 108 are used in common.

The reason that the illumination patterns shown in FIG. 5 are employed is described in detail with reference to FIG. 2. Generally, when the direction (the azimuth) of the optical axis of illumination perpendicularly crosses the direction (the azimuth) of a crack, an image of relatively high S/N ratio is obtained. For example, an image of relatively high S/N ratio is obtained when the direction of the crack is the up-down direction in FIG. 2 and the optical axes of illumination are the optical axis 111 and the optical axis 115. That is, illumination by the light source 101 and the light source 105 is the illumination with which an image of relatively high S/N ratio can be obtained.

If the direction of the crack is rotated 22.5° counterclockwise from the up-down direction in FIG. 2, the direction perpendicular to the direction of the crack is between the direction of the optical axis 111 and the direction of the optical axis 112, and between the direction of the optical axis 115 and the direction of the optical axis 116. Therefore, illumination by the light sources 101, 102, 105 and 106 is the illumination with which an image of relatively high S/N ratio can be obtained. However, since the angle between the direction of each of the optical axes 111, 112, 115 and 116 and the direction of the crack is 67.5°, the S/N ratio of an image is relatively low as compared with the above-described case where the direction of the optical axis and the direction of the crack is 90°.

Therefore, the illumination pattern illustrated in FIG. 5 is, in the case of the illumination pattern 1, for example, the illumination pattern that makes the mutually adjoining light sources 101 and 102 simultaneously emit light. With this illumination pattern, since a signal from the defect is increased (e.g., x2) and the noise is not increased to that degree of the signal (e.g., x√2), the S/N ratio of the image is improved.

If the direction of the crack is rotated 45° counterclockwise from the up-down direction in FIG. 2, the illumination pattern 2 that makes the light sources 102 and 103 simultaneously emit light is used to obtain an image of a relatively high S/N ratio. Here, the light emitting region (the light source) of the illumination pattern 2 and the light emitting region (the light source) of the illumination pattern 1 have an overlapping region (the light source 102).

As described above, in order to more precisely detect the scratch of all the directions, two illumination patterns (light emitting regions) corresponding to two adjoining azimuths have a mutually overlapping region. Plural mutually adjoining light sources are made to simultaneously emit light in one illumination pattern, and some of the light sources are used in common between two illumination patterns of which azimuths of the optical axes of illumination adjoin mutually in the above configuration. Alternatively, an illumination pattern that makes only one of the light sources 101 to 108 emit light can be added. In this case, an image of a relatively high S/N ratio is obtained in each case where the crack direction is, in FIG. 2, the up-down direction, the direction rotated 45° counterclockwise from the up-down direction, the direction rotated 90° counterclockwise from the up-down direction, and the direction rotated 135° counterclockwise from the up-down direction. Therefore, the S/N ratio of the later-described inspection image is increased depending on the direction of the crack.

Next, a parameter is initialized (step S2). Specifically, the processor 15 sets a parameter A that specifies the illumination pattern by the illumination device 11 to “1.” The processor 15 sets a parameter B that specifies a pixel as a target of a later-described inter-image operation (a maximum value-minimum value) to “1.”

Next, the processor 15 makes the illumination device 11 illuminate in the illumination pattern A (step S3). The processor 15 specifies the light source to emit light based on the information about the illumination pattern A obtained in step S1 and transmits the information to specify the light source (e.g., a light source number) to the control unit 14. The control unit 14 makes the light source corresponding to the received information among the light sources 101 to 108 which constitutes the illumination device 11 emit light. Subsequently or in parallel to the light emission, an image A is obtained (step S4). Specifically, the processor 15 causes the imaging device 12 to perform imaging and obtains the image A obtained by the imaging device 12.

Next, the processor 15 performs shading correction with respect to the image A to correct unevenness of pixel values resulting from the characteristic of the illumination device 11, the characteristic of the imaging device 12, the characteristic (e.g., light reflex characteristic) of the surface 100, etc. (step S5). The shading correction can be performed based on a corrected value set in advance for each illumination pattern so that the image A has a broadly uniform pixel value level. Next, the processor 15 normalizes each pixel value by standard deviation of all the pixel values with respect to the (image A)′ obtained by the shading correction (step S6).

Next, the processor 15 adds a value “1” to the parameter A (step S7), and determines whether the value of the parameter A exceeds the total number (here, 8) of types of the illumination patterns (step S8). If the value of the parameter A is less than or equal to the total number (the determination result is “No”), the processor 15 repeats the processes from step S3 to step S8. If the value of the parameter A is greater than the total number (the determination result is “Yes”), the processor 15 generates an inspection image using the obtained images 1 to 8 as input images.

In order to generate the inspection image, the processor 15 extracts the maximum pixel value and the minimum pixel value about the B-th pixel of each of the images 1 to 8, and obtains a value by subtracting the minimum pixel value from the maximum pixel value (maximum pixel value-minimum pixel value=subtraction value) (step S9). Next, the processor 15 adds a value “1” to the parameter B (step S10) and determines whether the value of the parameter B exceeds the total number of the pixels (step S11). If the value of the parameter B is less than or equal to the total number of the pixels (the determination result is “No”), the processor 15 repeats the processes from step S9 to step S11.

If the value of the parameter B is greater than the total number of the pixels (the determination result: yes), the processor 15 proceeds the process to step S12. In step S12, the processor 15 generates an inspection image of which B-th pixel value is the above subtraction value. The maximum pixel value or the minimum pixel value can be used instead of the subtraction value (maximum pixel value-minimum pixel value), which enables shortening the time to generate the inspection image in the inspection time (i.e., tact time).

The processor 16 performs processing regarding inspection of an object, such as processing to detect (extract) a defect, with respect to the thus obtained inspection image of the surface 100 of the work 10. The processing can be any of publicly known processing. According to the present embodiment, the S/N ratio of at least a part of the obtained images is improved without increasing the total number of the obtained images to obtain the inspection images. Therefore, an inspection apparatus advantageous in both accuracy and time consumption of inspection can be provided.

### Second Embodiment

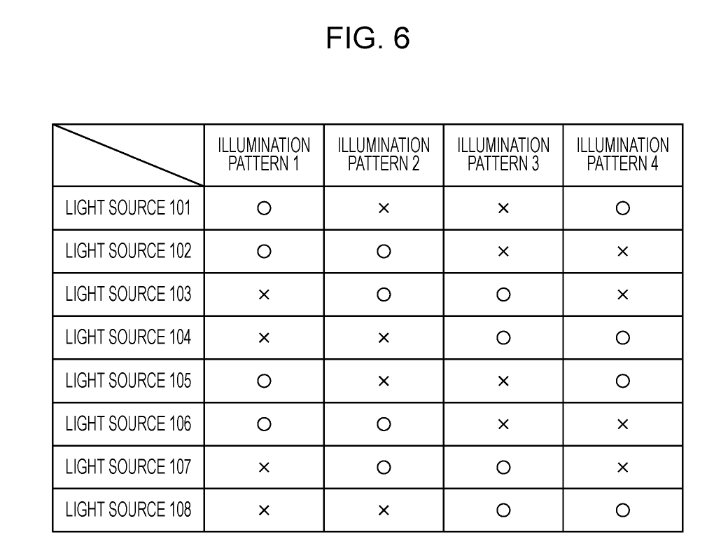

The present embodiment differs from the first embodiment in that the work 10 is simultaneously illuminated by mutually facing two illumination regions (light source groups). The term “facing” here refers to the azimuths of optical axes of two illuminations (i.e., illumination regions or light source groups) being in the opposite directions (substantially at 180° from each other). Illumination patterns of the present embodiment are described with reference to FIG. 6.

FIG. 6 illustrates another exemplary relationship between illumination patterns and light emission states of light sources. FIG. 6 illustrates correlations between the illumination patterns 1 to 4 (4 azimuths) and the light emission states of the light sources 101 to 108. For example, the illumination pattern 1 makes the light sources 101, 102, 105 and 106 emit light (o) and does not make other light sources 103, 104, 107 and 108 emit light (x). The light sources 101 and 102 face the light sources 105 and 106, respectively.

The work 10 is simultaneously illuminated from the two facing illumination regions for the following reason. That is, an image obtained in one of the two illumination regions and an image obtained in the other of the two illumination regions have substantially the same S/N ratio, and an image obtained in both of the two illumination regions has a S/N ratio greater than the above S/N ratio. With the increase of such an illumination region, the rate of increase in the signal becomes greater than the rate of increase in noise, whereby the S/N ratio improves.

### Third Embodiment

In the above embodiments, two light emitting regions among plural light emitting regions each corresponding to two mutually adjoining azimuths among plural azimuths which illuminate an object have an overlapping region. The illumination device 11 includes plural light sources corresponding to each of the two light emitting regions, and some of the plurality of light sources correspond to the overlapping region. The present embodiment differs from the above embodiments in that a processor 15 obtains one image corresponding to the plurality of light sources by adding an image obtained by some of the plurality of light sources and an imaging device 12 and an image obtained by the other of the plurality of light sources and the imaging device 12. Some of the light sources and the other of the light sources are made to emit light sequentially.

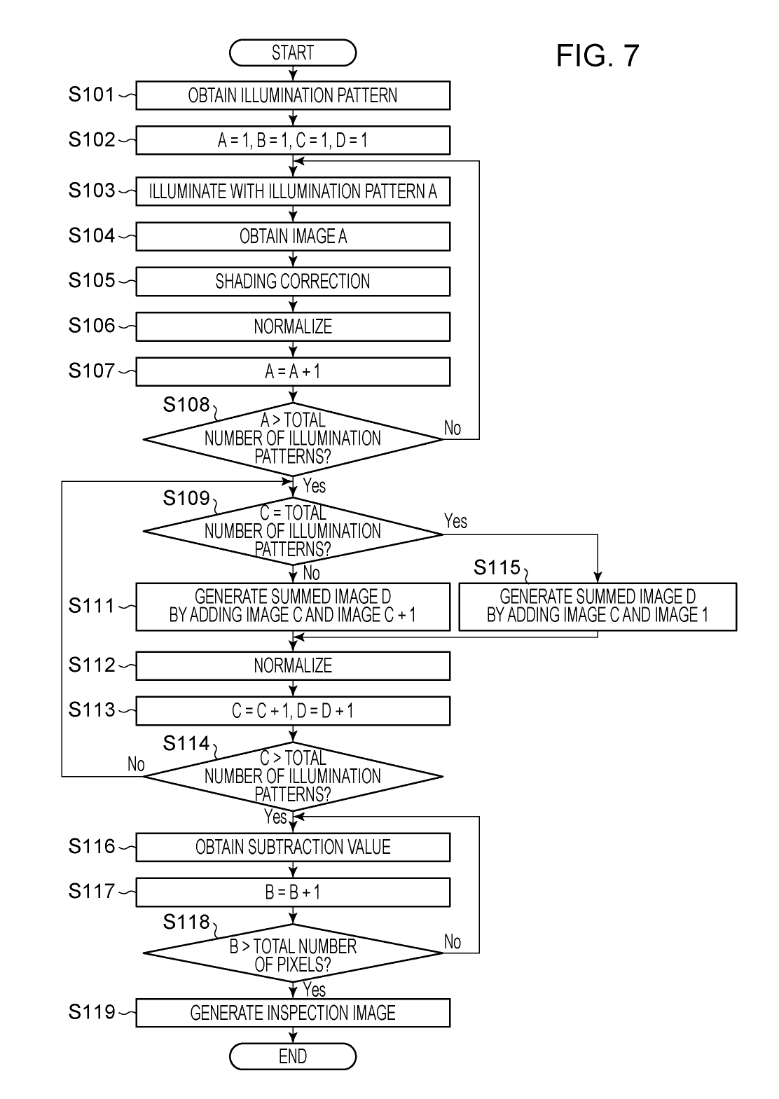

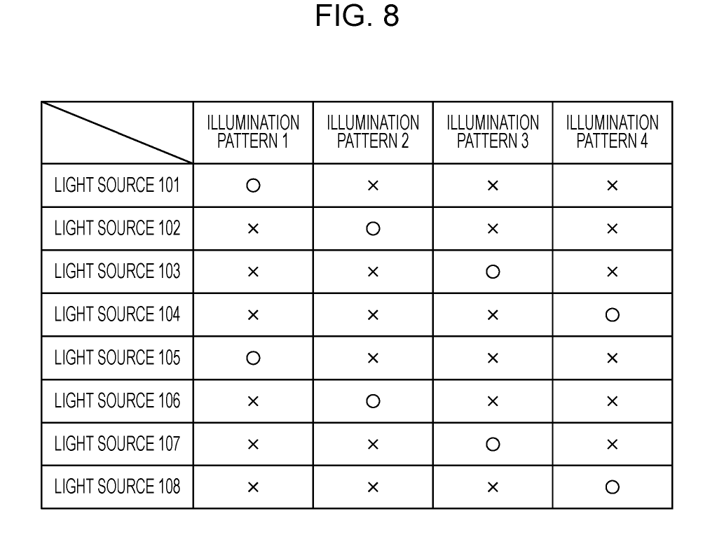

Generation of an inspection image is described with reference to FIGS. 7 and 8. FIG. 7 illustrates a processing flow to generate an inspection image. FIG. 8 illustrates other exemplary relationships between illumination patterns and light emission states of the light sources. In FIG. 7, an illumination pattern is obtained (set) first (step S101). The illumination pattern (the light emitting region) is described with reference to FIG. 8.

FIG. 8 illustrates correlations between the illumination patterns 1 to 4 and the light emission states of the light sources 101 to 108. For example, the illumination pattern 1 makes the light sources 101 and 105 emit light (o) and does not make other light sources emit light (x). Effects of using the facing illumination regions in this manner are the same as described in the second embodiment.

Next, a parameter is initialized (step S102). Specifically, the processor 15 sets a parameter A which specifies the illumination pattern by the illumination device 11 to “1.” The processor 15 sets a parameter B that specifies a pixel as a target of an inter-image operation (maximum value-minimum value) to “1.” The processor 15 sets a parameter C that specifies an image obtained (acquired) for each illumination pattern to “1,” and sets a parameter D which specifies an image obtained by addition to “1.”

Next, the processor 15 makes the illumination device 11 to illuminate in the illumination pattern A (step S103). The processor 15 specifies the light source to emit light based on the information about the illumination pattern A obtained in step S101 and transmits the information to specify the light source (e.g., a light source number) to the control unit 14. The control unit 14 makes the light source corresponding to the received information among the light sources 101 to 108 which constitutes the illumination device 11 emit light. Subsequently or in parallel to the light emission, an image A is obtained (step S104). Specifically, the processor 15 causes the imaging device 12 to perform imaging and obtains the image A obtained by the imaging device 12.

Next, the processor 15 performs shading correction with respect to the image A to correct unevenness of pixel values resulting from the characteristic of the illumination device 11, the characteristic of the imaging device 12, the characteristic (e.g., light reflex characteristic) of the surface 100, etc. (step S105). The shading correction can be performed based on a corrected value set in advance for each illumination pattern so that the image A has a broadly uniform pixel value level. Next, the processor 15 standardizes (normalizes) each pixel value by standard deviation of all the pixel values with respect to the (image A)′ obtained by the shading correction (step S106).

Next, the processor 15 adds a value “1” to the parameter A (step S107) and determines whether the value of the parameter A exceeds the total number (here, 4) of types of the illumination patterns (step S108). If the value of the parameter A is less than or equal to the total number (the determination result is “No”), the processor 15 repeats the processes from step S103 to step S108. If the value of the parameter A is greater than the total number (the determination result is “Yes”), the processor 15 generates a summed image based on the obtained images 1 to 4.

Next, the processor 15 determines whether the value of the parameter C is equal to the total number of the illumination patterns (step S109). If the value of the parameter C is not equal to the total number (the determination result is “No”), the processor 15 obtains a summed image D by adding an image C and an image C+1 for each pixel (step S111), and proceeds processing to standardize the summed image D (step S112). If the value of the parameter C is equal to the total number (the determination result is “Yes”), the processor 15 adds the image C and the image 1 for each pixel to obtain the summed image D (step S115), and proceeds processing to standardize the summed image D (step S112). Obtaining the summed image here has the same or equivalent effect as that in obtaining an image by imaging while simultaneously illuminating from the illumination regions (light sources) of mutually adjoining illumination azimuths, that is, it has an effect of improving an S/N ratio of an image.

Next, the processor 15 standardizes (normalizes) each pixel value by standard deviation of all the pixel values with respect to the summed image D (step S112).

Next, the processor 15 adds a value “1” to each of the parameter C and the parameter D (step S113). The processor 15 then determines whether the value of the parameter C exceeds the total number (here, 4) of the illumination patterns (step S114). If the value of the parameter C is less than or equal to the total number (the determination result is “No”), the processor 15 repeats the processes from step S109 to step S114. If the value of the parameter C is greater than the total number (the determination result is “Yes”), the processor 15 generates an inspection image using the summed images 1 to 4 as input images.

In order to generate the inspection image, the processor 15 extracts the maximum pixel value and the minimum pixel value about the B-th pixel of each of the images 1 to 4, and obtains a value by subtracting the minimum pixel value from the maximum pixel value (maximum pixel value-minimum pixel value=subtraction value) (step S116). Although only the summed images 1 to 4 are used as the input images, the images 1 to 4 can be added so that the total number of the input images becomes eight. The images 1 to 4 have high S/N ratios when the direction of the crack in FIG. 2 is the up-down direction, the direction rotated 45° counterclockwise from the up-down direction, the direction rotated 90° counterclockwise from the up-down direction, and the direction rotated 135° counterclockwise from the up-down direction as compared with those of the summed images 1 to 4. Therefore, if the images 1 to 4 are added to the input images, the S/N ratios of the inspection image with respect to the direction of the crack corresponding to these images improve.

Next, the processor 15 adds the value “1” to the parameter B (step S117) and determines whether the value of the parameter B exceeds the total number of pixels (step S118). If the value of the parameter B is less than or equal to the total number of the pixels (the determination result is “No”), the processor 15 repeats the processes from step S116 to step S118. If the value of the parameter B is greater than the total number of the pixels (the determination result: yes), the processor 15 proceeds the process to step S119. In step S119, the processor 15 generates an inspection image of which B-th pixel value is the above subtraction value. The maximum pixel value or the minimum pixel value can be used instead of the subtraction value (maximum pixel value-minimum pixel value), which enables shortening the time to generate the inspection image in the inspection time (i.e., tact time).

The processor 16 performs processing regarding inspection of an object, such as processing to detect (extract) a defect, with respect to the thus obtained inspection image of the surface 100 of the work 10. The processing can be any of publicly known processing. Although shading correction and standardization are performed on the images 1 to 4 in step S105 and S106, respectively, these processings can be omitted. Instead, shading correction and standardization can be performed on the input images (i.e., the summed images 1 to 4 and, if necessary, the images 1 to 4). According to the present embodiment, the S/N ratio of at least a part of the obtained images is improved without increasing the total number of the obtained images to obtain the inspection images. Therefore, an inspection apparatus advantageous in both accuracy and time consumption of inspection can be provided.

### Embodiment Related to Article Manufacturing Method

The inspection apparatus according to the above-described embodiments can be used in an article manufacturing method. The article manufacturing method can include a step of inspecting an object using the inspection apparatus, and a step of processing the object inspected in the inspection process. The processing can include at least any one of measurement, processing, cutting, conveyance, building (assembly), inspection and sorting, etc. The method of manufacturing an article according to the present embodiment is advantageous in at least one of performance, quality, productivity and production cost of an article as compared with those of the related art methods.

Various embodiments of the present invention have been described, but the aspects of the invention are not limited to the same. Modifications and changes can be made without departing from the scope of the aspects of the invention.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-194023, filed Sep. 30, 2015, which is hereby incorporated by reference herein in its entirety.

1. An inspection apparatus for performing inspection of an object, the inspection apparatus comprising:
an illumination device configured to illuminate the object;
an imaging device configured to image the illuminated object; and
a processor configured to perform inspection processing based on plural images obtained by the imaging device respectively corresponding to plural light emitting regions of the illumination device,
wherein the inspection apparatus is configured such that two light emitting regions of the plural light emitting regions respectively corresponding to mutually adjoining two azimuths of plural azimuths that illuminate the object have a mutually overlapping region.

2. An inspection apparatus according to claim 1, wherein the illumination device is configured to perform a dark field illumination for the object.

3. An inspection apparatus according to claim 1, wherein the illumination device includes plural light sources respectively corresponding to each of the two light emitting regions, wherein a part of the plural light sources corresponds to the overlapping region.

4. An inspection apparatus according to claim 3, wherein the processor is configured to obtain at least one of the plural images by addition of an image obtained by one part of the plural light sources and the imaging device, and an image obtained by another part of the plural light sources and the imaging device.

5. An inspection apparatus according to claim 3, wherein plural groups of the plural light sources are disposed to be rotationally symmetric with respect to an optical axis of the imaging device.

6. An inspection apparatus according to claim 1, wherein the processor is configured to generate an inspection image based on the plural images, and perform the inspection processing based on the inspection image.

7. An inspection apparatus according to claim 1, wherein the processor is configured to obtain the inspection image based on at least one of a maximum pixel value and a minimum pixel value with respect to each group of corresponding plural pixels in the plural images.

8. An inspection apparatus according to claim 1, wherein the inspection apparatus is configured such that the plural azimuths include four azimuths.

9. An inspection apparatus according to claim 1, wherein the imaging device is configured to image the object illuminated by the illumination device from two azimuths opposite to each other with respect to an optical axis of the imaging device to obtain each of the plural images.

10. An inspection apparatus according to claim 1, wherein the inspection apparatus is configured such that the plural azimuths include eight azimuths.

11. An inspection apparatus for performing inspection of an object, the inspection apparatus comprising:
an illumination device configured to illuminate the object;
an imaging device configured to image the illuminated object; and
a processor configured to perform inspection processing based on plural images obtained by the imaging device respectively corresponding to plural light emitting regions of the illumination device,
wherein the inspection apparatus is configured such that one of the plural light emitting regions corresponding to one of plural azimuths that illuminate the object corresponds to mutually adjoining two light sources.

12. An inspection apparatus according to claim 11, wherein the processor is configured to cause the two light sources to simultaneously emit light to obtain an image by the imaging device.

13. An inspection apparatus according to claim 11, wherein the processor is configured to sequentially add two images obtained by the imaging device by causing the two light sources to sequentially emit light.

14. A method of manufacturing an article, the method comprising steps of:
performing inspection of an object using an inspection apparatus; and
processing the inspected object to manufacture the article,
wherein the inspection apparatus includes:
an illumination device configured to illuminate the object;
an imaging device configured to image the illuminated object; and
a processor configured to perform inspection processing based on plural images obtained by the imaging device respectively corresponding to plural light emitting regions of the illumination device,
wherein the inspection apparatus is configured such that one of the plural light emitting regions corresponding to one of plural azimuths that illuminate the object corresponds to mutually adjoining two light sources.

15. (canceled)

16. A method for controlling an inspection apparatus, the method comprising:
illuminating an object;
imaging, at an imaging device, the illuminated object; and
performing inspection processing based on plural images obtained by the imaging device respectively corresponding to plural light emitting regions of the illumination device,
wherein the inspection apparatus is configured such that two light emitting regions of the plural light emitting regions respectively corresponding to mutually adjoining two azimuths of plural azimuths that illuminate the object have a mutually overlapping region.
